(19) United States
(12) Patent Application Publication
(10) Pub. No.: US 2008/0215375 A1
(43) Pub. Date: Sep. 4, 2008

(54) Communication system for indemnification insurance service

(75) Inventors: Nobutoshi Nakano, Tokyo (JP); Hitoshi Hara, Tokyo (JP); Mineaki Matsumura, Yao-shi (JP); Shinsuke Kawaguchi, Fukuoka-shi (JP)

Correspondence Address: NIXON & VANDERHYE, PC, 901 NORTH GLEBE ROAD, 11TH FLOOR, ARLINGTON, VA, 22203, US

(73) Assignee: BIT CORN LABORATORY, INC.,, Tokyo (JP)

(21) Appl. No.: 11/907,706

(22) Filed: Oct. 16, 2007

(30) Foreign Application Priority Data
Mar. 3, 2007 (JP) 2007-056940

(51) Int. Cl. G06Q 40/00; G06Q 90/00

(52) U.S. Cl. 705/4

(57) ABSTRACT

The object of the present invention is to provide a communication system for indemnification insurance service; the system contributes to rapid procedures to be performed from the occurrence of an accident to the arrival of a staff to the accident scene, including notification to the company of the indemnification insurance service, and certification of the location of the accident scene and the content of the insurance service of the insured, performed inside the company. The communication system for indemnification insurance service 1 comprises: a cell phone 2 with a built-in IC tag reader and a server 3, which are communicably connected with each other over the internet 4; and a management terminal 5 communicably connected with the server 3; and wherein the cell phone 2 comprises: a means 21 operable to read out information from the insurance IC tag 8, which is provided with the insurance card 6 possessed by the policyholder and stores insurance information; a means 22 for transmitting its cell phone number and the policyholder's name read out from the insurance IC tag 8, to the server 3 at a URL read out form the insurance IC tag 8; and a means 23 for receiving an authentication result from the server 3. Here, the means 21 is operable to re-read out the policyholder's name and the insurance policy number from the insurance IC tag 8, when the authentication result indicates being authenticated.

### FIELD OF THE INVENTION

The present invention relates to a communication system for indemnification insurance service, particularly to the system, which in order to contribute to rapid procedures of the indemnification insurance service after the occurrence of an accident, help unify procedures and/or managements including a notification to an indemnification insurance company, a certification of the content of the insurance policy, and those therebetween.

### BACKGROUND OF THE INVENTION

Indemnification insurance services aim to cover losses and/or damages suffered by an accident; are roughly classified into categories such as a fire insurance service, a marine insurance service, a car insurance service and so on; help recovery of the life and/or healthy, and cover losses and/or damages to the insured's properties, wages, lost earnings and so on. These insurance services are provided by the companies of the indemnification insurance service; these companies, when the insured should encounter an accident, calculate and sum up the insurance benefits by certifying losses and/or damages of the insured and comparing them with the insurance policy of the insured, and then cover the economic losses.

Regarding the content of the insurance policy, the content of the insurance policy issued at the contract is going to be compared with the data stored by the company. However, the insurance policy may not be carried by the insured, even it is lost. Accordingly, until the arrival of a staff, a long time may be wasted for the notification after the occurrence of an accident, certification inside a company of an indemnification insurance service, and other procedures. Therefore, there are demands for rapid procedures after the occurrence of losses and/or damages. In a patent document 1, there is described an emergency information notification system for allowing to notify the company of the indemnification insurance service concerning the occurrence of an accident.

[Patent Document 1]

Japanese Patent Application Laid-Open Publication 2003-078654

As described above, until the arrival of a staff, a long time may be wasted for the notification after the occurrence of an accident, certification inside a company of an indemnification insurance service, and other procedures, conventionally. Further, although the technology described in the aforementioned patent document 1 enables to notify the company of the indemnification insurance service regarding the occurrence of an accident, it doesn't enable to certify regarding the content of the indemnification insurance service based on the notification. Moreover, a simpler and economical system is demanded for a communication system for enabling procedures performed until the arrival of the staff to the accident scene, including notification to the company and certification inside the company of the indemnification insurance service, after the occurrence of an accident.

Considering the aforementioned of the state of the art, the object of the present invention is to provide a communication system for indemnification insurance service; the system contributes to rapid procedures to be performed from the occurrence of an accident to the arrival of a staff to the accident scene, including notification to the company of the indemnification insurance service, and certification of the location of the accident scene and the content of the insurance service of the insured, performed inside the company.

### SUMMARY OF THE INVENTION

The aforementioned objective is achieved by the following configurations.

(1) According to the claim 1, there is provided a communication system for indemnification insurance service, the system comprising: a cell phone with a built-in IC tag reader; a server communicably connected with said cell phone over the internet; and a management terminal communicably connected with said management server;

wherein said cell phone includes:

a reading means operable to read, after such as an occurrence of an accident, insurance service information stored in an insurance IC tag provided with an insurance card possessed by a policyholder of the indemnification insurance service;

a transmitting means for transmitting its cell phone number and a policyholder's name read from said insurance IC tag to said server at a URL read from said insurance IC tag;

a receiving means for receiving an authentication result from said server, wherein when the authentication result indicates being authenticated, said reading means is operable to re-read the policyholder's name and the insurance policy number from said insurance IC tag;

a displaying means for displaying the re-read information;

a means for prompting, on a display, the policyholder to select whether to notify regarding an occurrence of an accident or not; and

a measuring means for measuring the present location of the cell phone based on the GPS, wherein said transmitting means transmits the policyholder's name, the insurance policy number, and the present location to the server; and wherein said server includes:

a member database for storing the information on the policyholder of the indemnification insurance service;

an authentication means for authenticating, when the cell phone number and the policyholder' name have received from the cell phone, by matching them with data in said member database;

a transmitting means for transmitting the authentication result to the cell phone;

a means for storing the policyholder' name, the insurance policy number, and the present location to said member database, when these data have received; and

a searching means for searching the content of the insurance policy from said member database, wherein, said transmitting means transmits the content of the insurance policy and the present location to said management terminal; and wherein said management terminal includes:

a means for displaying the content of the insurance policy and also displaying the present location on a map, on receiving these data.

(2) According to the claim 2, there is provided a communication system for indemnification insurance service, the system comprising: a cell phone with a built-in IC tag reader; a server communicably connected with said cell phone over the internet; and a management terminal communicably connected with said management server;

wherein said cell phone includes:

a reading means operable to read, after such as an occurrence of an accident and/or trouble of a car, member insurance service information stored in an insurance IC tag attached to the car;

a transmitting means for transmitting its cell phone number and a policyholder's name read from said insurance IC tag to said server at a URL read from said insurance IC tag;

a receiving means for receiving an authentication result from said server, wherein when the authentication result indicates being authenticated, said reading means is operable to re-read the policyholder's name and the insurance policy number from said insurance IC tag;

a displaying means for displaying the re-read information;

a means for prompting, on a display, the policyholder to select whether to notify regarding an occurrence of an accident or not; and

a measuring means for measuring the present location of the cell phone based on the GPS, wherein said transmitting means transmits the policyholder's name, the insurance policy number, and the present location to the server;

and wherein said server includes:

a member database for storing the information on the policyholder of the indemnification insurance service;

an authentication means for authenticating, when the cell phone number and the policyholder' name have received from the cell phone, by matching them with data in said member database;

a transmitting means for transmitting the authentication result to the cell phone;

a means for storing the policyholder' name, the insurance policy number, and the present location to said member database, when these data have received; and

a searching means for searching the content of the insurance policy from said member database, wherein, said transmitting means transmits the content of the insurance policy and the present location to said management terminal; and wherein said management terminal includes:

a means for displaying the content of the insurance policy and also displaying the present location on a map, on receiving these data.

(3) According to the claim 3, there is provided a communication system for indemnification insurance service according to claim 2, wherein

said management terminal is communicably connected with a car repair shop terminal installed in a car repair shop;

said transmitting means of said management terminal transmits the content of the insurance policy and the present location to the car repair shop terminal, on receiving these data from said server; and

said car repair shop terminal includes a means for displaying the content of the insurance policy and the present location, on receiving these data from said management terminal.

(4) According to the claim 4, there is provided a communication system for indemnification insurance service, the system comprising: a staff dedicated terminal with a built-in IC chip reader and a built-in IC tag reader, carried by a staff of a company of an indemnification insurance service; and a server communicably connected with said staff dedicated terminal over the internet;

wherein said staff dedicated terminal includes:

a reading means operable to read a biometric authentication identifier stored in an IC chip provided with a company staff card of the staff of the indemnification insurance company;

an authentication identifier capturing means for capturing a biometric authentication identifier from the staff of the indemnification insurance company; and

an authenticating means for authenticating the staff of an indemnification insurance company, wherein said reading means is operable to read biometric authentication identifier stored in the IC chip of an insurance card possessed by a policyholder of the indemnification insurance service, said authentication identifier capturing means is operable to capture biometric authentication identifier of the policy holder, said authenticating means authenticates the policyholder, and said reading means, when said staff of the company of the indemnification insurance service and said policyholder are authenticated, is operable to read indemnification insurance service information of said policyholder from the insurance IC tag of the insurance card;

and wherein said staff dedicated terminal further includes:

a transmitting means for transmitting the policyholder's name read from the insurance IC tag to the server at a URL read from the insurance IC tag;

a receiving means for receiving an authentication result from said server;

a displaying means for displaying the insurance IC tag information read from said insurance IC tag, when the authentication result indicates being authenticated, wherein after being authenticated, the reading means is operable to read examination information of a car from a car examination IC tag attached to the car, and the displaying means displays examination information of the car; and wherein said staff dedicated terminal further includes:

an inputting means for allowing the staff to input data on procedures and/or managements regarding the accident at the accident scene, wherein after the data input, the transmitting means transmits the car examination IC tag information and the input data to the server;

and wherein said staff dedicated terminal further includes:

a writing means operable to write the input data to the insurance IC tag of the insurance card and the insurance IC tag attached to the car;

and wherein said server includes:

a member database for storing the information on the policyholder of the indemnification insurance service;

an authentication means for authenticating, when the insurance IC tag information of the insurance card has been received from the staff dedicated terminal, by matching them with data in said member database;

a transmitting means for transmitting the authentication result to the staff dedicated terminal; and

a means for storing the car examination IC tag information and the input data to the member database, when these data have received.

(5) According to the claim 5, there is provided a communication system for indemnification insurance service according to claim 4, wherein said staff dedicated terminal includes a writing means operable to write historical data of a happened accident(s) and/or trouble(s) to the insurance IC tag attached to the car and the insurance IC tag of the insurance card.

(6) According to the claim 6, there is provided a communication system for indemnification insurance service according to claim 4, wherein, wherein said car examination IC tag is capable to be updated regarding the historical data of repair therein, by a shop dedicated terminal installed in a car repair shop.

According to the present invention defined in claim 1, it is possible to provide a communication system for indemnification insurance service; the system contributes to rapid procedures to be performed from the occurrence of an accident to the arrival of a staff to the accident scene, including notification to the company of the indemnification insurance service, and certification of the location of the accident scene and the content of the insurance service of the insured, performed inside the company.

According to the present invention defined in claim 2, it is possible to provide a communication system for indemnification insurance service; the system contributes to rapid procedures to be performed from the occurrence of an accident to the arrival of a staff to the accident scene, including notification to the company of the indemnification insurance service, and certification of the location of the accident scene and the content of the insurance service of the insured, performed inside the company.

According to the present invention defined in claim 3, in addition to the aforementioned advantage of the invention defined in claim 2, it is possible to communicate to a car repair shop rapidly, when an accident or trouble of a car has occurred.

According to the present invention defined in claim 4, it is possible to provide a communication system for indemnification insurance service; the system contributes to rapid procedures to be performed from the occurrence of an accident to the arrival of a staff to the accident scene, including notification to the company of the indemnification insurance service, and certification of the location of the accident scene and the content of the insurance service of the insured, performed inside the company.

According to the present invention defined in claim 5, in addition to the aforementioned advantage of the invention defined in claim 4, it is possible to write the historical data of car accidents or troubles to the insurance IC tag attached to the car and the insurance IC tag of the insurance card by the staff dedicated terminal.

According to the present invention defined in claim 6, in addition to the aforementioned advantage of the invention defined in claim 4, it is possible to update the historical data of repair stored in the car IC tag attached to the car, by a shop dedicated terminal installed in a car repair shop.

### BRIEF DESCRIPTION OF THE DRAWINGS

FIG. 1 shows a view roughly illustrating a communication system for indemnification insurance service according to the first embodiment of the present invention.

FIG. 2 shows a view explaining function of a communication system for indemnification insurance service according to the first embodiment of the present invention.

FIG. 3 shows a diagram illustrating a flowchart for explaining the processes performed in a communication system for indemnification insurance service according to the first embodiment of the present invention.

FIG. 4 shows a view roughly illustrating a communication system for indemnification insurance service according to the second embodiment of the present invention.

FIG. 5 shows a view explaining function of a communication system for indemnification insurance service according to the second embodiment of the present invention.

FIG. 6 shows a diagram illustrating a flowchart for explaining the processes performed in a communication system for indemnification insurance service according to the second embodiment of the present invention.

FIG. 7 shows a view roughly illustrating a communication system for indemnification insurance service according to the third embodiment of the present invention.

FIG. 8 shows a view explaining function of a communication system for indemnification insurance service according to the third embodiment of the present invention.

FIG. 9 shows a diagram illustrating a flowchart for explaining the processes performed in a communication system for indemnification insurance service according to the third embodiment of the present invention.

### DETAILED DESCRIPTION OF THE PREFERRED EMBODIMENTS

Hereinafter, with reference to the drawings which show illustrative examples, described are embodiments in accordance with the present invention. Here, for the sake of explanation, the same reference numerals are used for indicating the same portions or portions having similar function, in the same embodiment and even in the different embodiment.

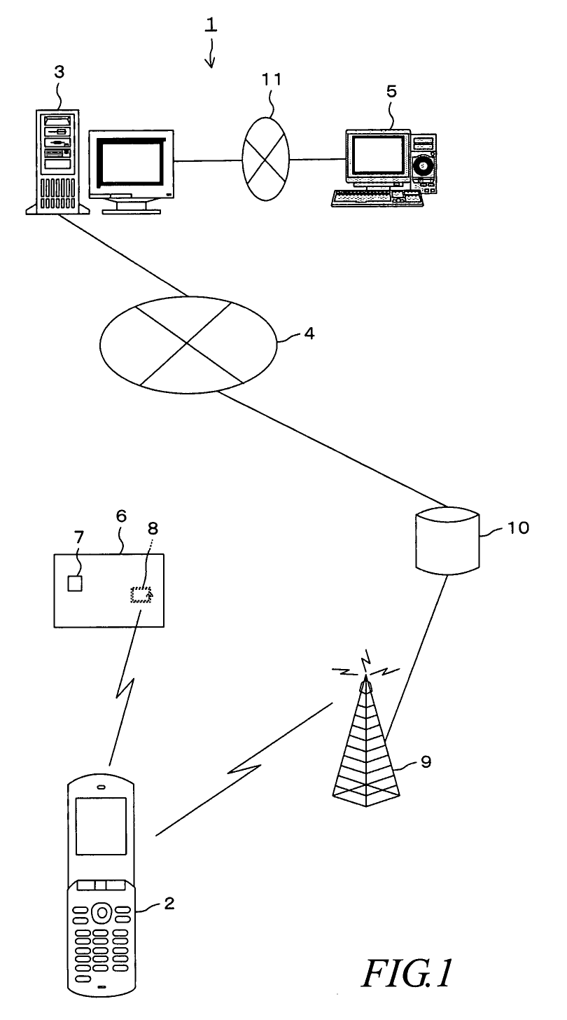

In FIG. 1, reference numeral 1 denotes a communication system for indemnification insurance service according to the first embodiment of the present invention; and the system is applicable to the whole indemnification insurance services.

The communication system for indemnification insurance service 1 comprises: a cell phone 2 with a built-in IC tag reader and a server 3, which are communicably connected with each other over the internet 4; and a management terminal 5 communicably connected with the server 3.

In FIG. 1, reference numeral 6 denotes an insurance card possessed by a policyholder. The insurance card 6 includes an IC chip 7 for storing the biometric authentication identifier of the policyholder, and an insurance IC tag 8 for storing insurance service information of the policyholder, including such as the policyholder's name, URL of the server, insurance policy number.

Further, in the Figure, reference numeral 9 denotes a cell station of the cell phone 2, reference numeral 10 denotes a cell site, and reference numeral 11 denotes a communication network communicably connecting between the server 3 and the management terminal 5, respectively.

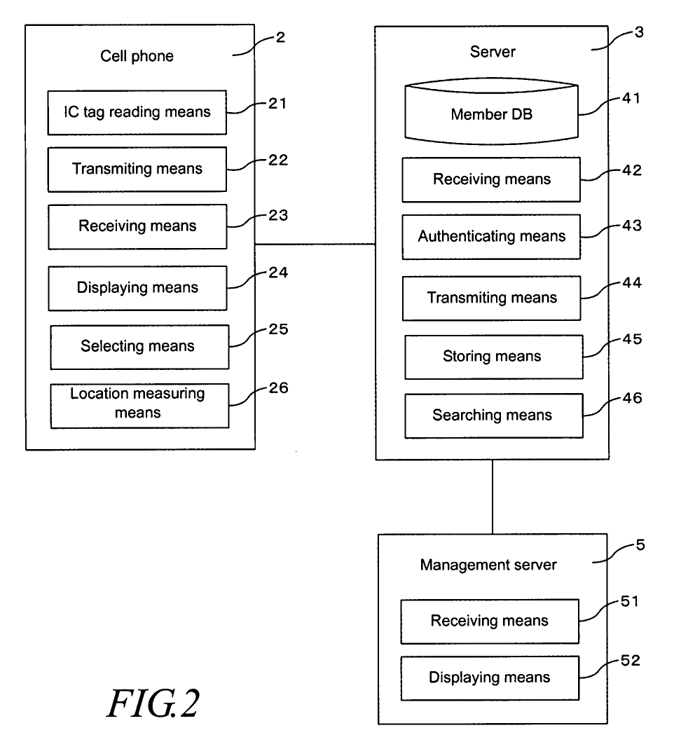

As shown in FIG. 2, the cell phone 2 comprises: an IC tag reading means 21 operable to read out information from the insurance IC tag 8, which is provided with the insurance card 6 possessed by the policyholder and stores insurance information; a transmitting means 22 for transmitting its cell phone number and the policyholder's name read out from the insurance IC tag 8, to the server 3 at a URL read out form the insurance IC tag 8; and a receiving means 23 for receiving an authentication result from the server 3. Here, the IC tag reading means 21 is operable to re-read out the policyholder's name and the insurance policy number from the insurance IC tag 8, when the authentication result indicates being authenticated.

The cell phone 2 further comprises: a displaying means 24 for displaying the information re-read out; a selection means 25 for prompting the policyholder on the display to select whether to notify concerning the occurrence of an accident or not; and a location measuring means 26 for measuring the present location of the cell phone 2 based on the GPS. Here, the transmitting means 22 is capable of transmitting the policyholder's name, the insurance policy number, and the present location to the server 3.

The server 3 comprises: a member database 41 for storing the information on insurance polices of indemnification insurance services, for respective policyholders; a receiving means 42 for receiving the cell phone number and the policyholder's name from the cell phone 2; an authenticating means 43 for authenticating the received data by matching them with the data in the member database 41; a transmitting means 44 for transmitting the authentication result to the cell phone 2; a storing means 45 for storing the policyholder's name, the insurance policy number, and the present location to the member database 41, when these data are received; and a searching means 46 for searching the content of the insurance policy from the member database 41. Here, the transmitting means 44 is capable of transmitting the content of the insurance policy and the present information to the management terminal 5.

And the management terminal 5 comprises: a receiving means 51 for receiving the content of the insurance policy and the present location from the server 3; and a displaying means 52 for displaying the received content of the insurance policy, and also displaying the present location on a map.

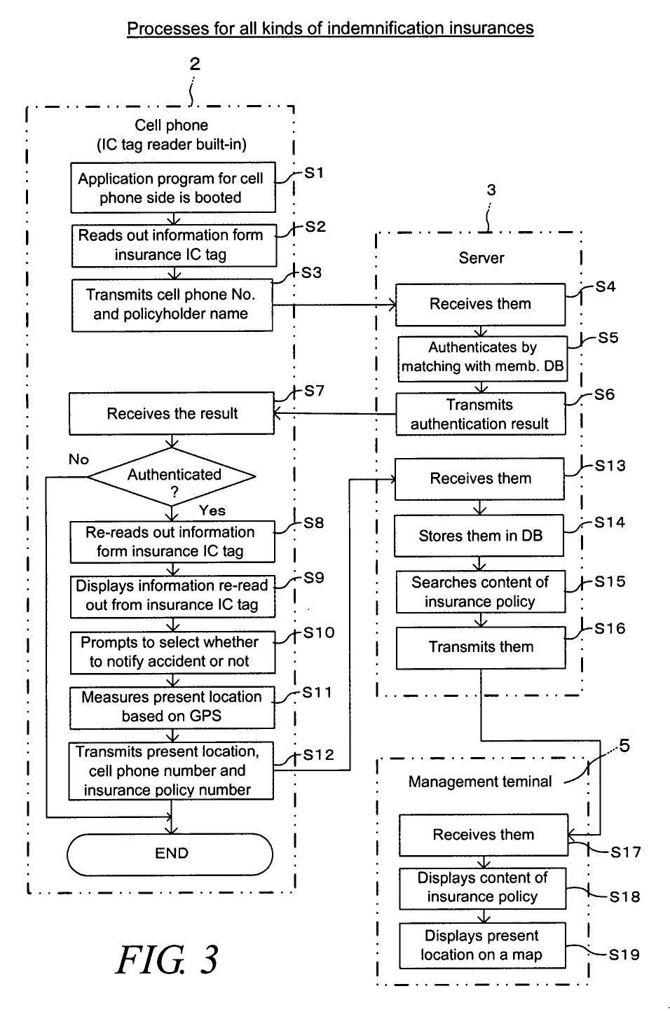

FIG. 3 is a diagram illustrating a flowchart for explaining the processes performed in a communication system for indemnification insurance service according to the first embodiment.

When an accident has occurred, the application program (hereinafter, simply being referred to as “application”.) for realizing the function on the cell phone 2 side is booted by the policyholder (step S1); the insurance service information is read out by the cell phone 2 from the insurance IC tag 8, which is provided with the insurance card 5 of the policyholder and stores the insurance service information (step S2), and the cell phone 2 transmits the cell phone number and the policyholder's name read out from the insurance IC tag 8 to the server 3 at a URL read out from the insurance IC tag 8 (step S3).

The server 3, when having received the cell phone number and the policyholder's name from the cell phone 2 (step S4), authenticates the received data by matching them with data in the member database 41 (step S5), and transmits the authentication result to the cell phone 2 (step S6).

The cell phone 2 receives the authentication result from server 3 (step S7); when the authentication result indicates being authenticated, the terminal is allowed to re-read out the policyholder's name and the insurance policy number from the insurance IC tag 8 (step S8), and displays the information re-read out (step S9). The cell phone 2 prompts on display to select whether to notify concerning the occurrence of the accident or not (step S10); when the notification of an accident to the server 3 is chosen by the policyholder, the cell phone 2 measures the present location of the cell phone 2 based on the GPS (step S11), and transmits the policyholder's name, the insurance policy number, and the present location (step S12). Here, when the authentication result received at the step S7 doesn't indicate being authenticated, the process terminates.

The server 3, when having received the policyholder's name, the insurance policy number, and the present location from the cell phone 2 (step S13), stores the received information to the member database 41 (step S14), searches the content of the insurance policy from the member database 41 (step S15), and transmits the content of the insurance policy and the present location to the management terminal 5 (step S16).

The management terminal 5, when having received the content of the insurance policy and the present location (step S17), displays the content of the insurance policy (step S18), and also displays the present location on a map (step S19).

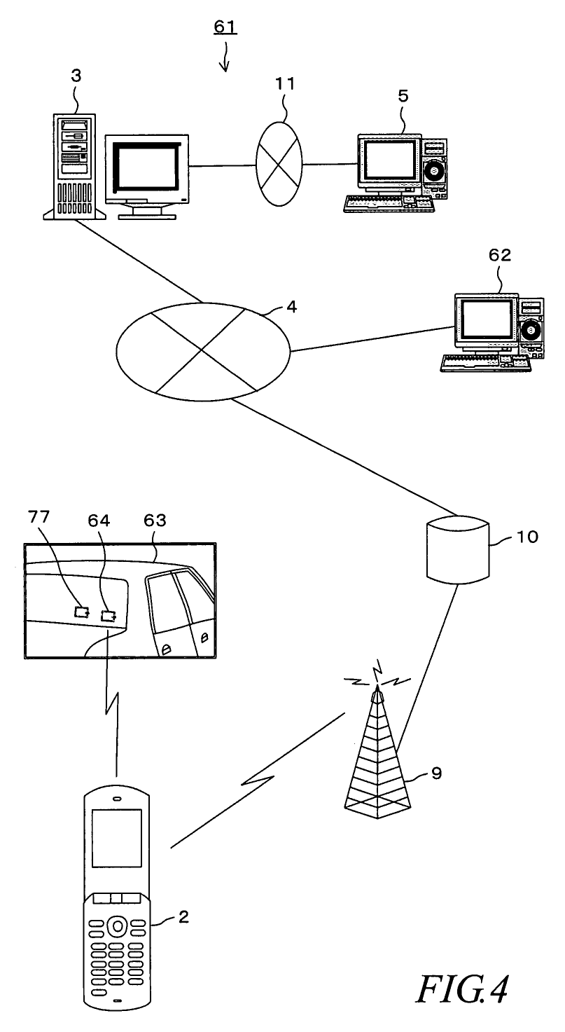

In FIG. 4, reference numeral 61 denotes a communication system for indemnification insurance service, applicable to car insurance service according to the second embodiment of the present invention.

The communication system for indemnification insurance service 61 comprises: a cell phone 2 with a built-in IC tag reader and a server 3, which are communicably connected with each other over the internet 11; and a management terminal 5 communicably connected with the server 3.

Further, the management terminal 5 is communicably connected to a car repair shop terminal 62 installed in a car repair shop. Here, in FIG. 4, reference numeral 63 denotes a car, and reference numeral 64 denotes an insurance IC tag, which is attached to the car 63 and stores member insurance service information of the policyholder, including such as the policyholder's name, URL of the server, insurance policy number.

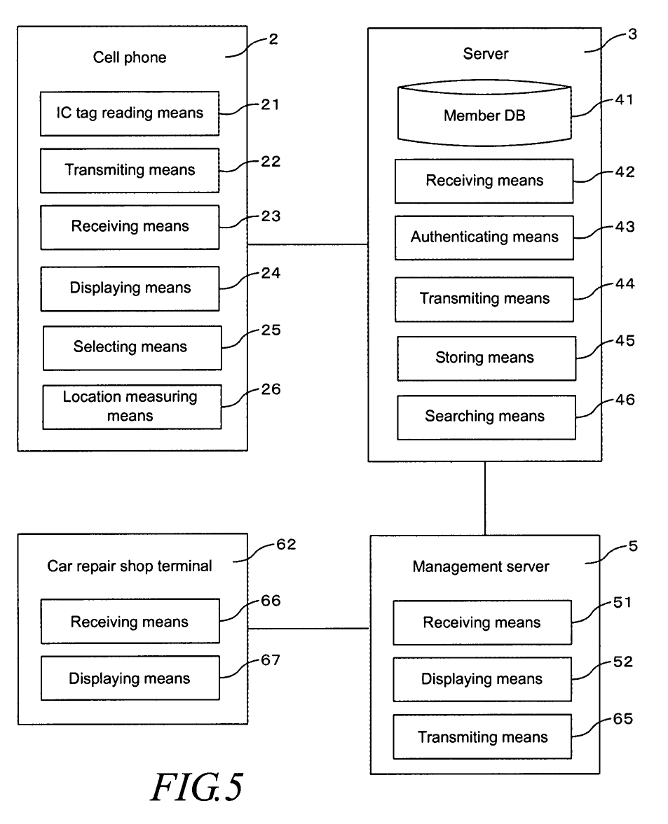

As shown in FIG. 5, the cell phone 2 comprises: a reading means 21 operable to read out information from the insurance IC tag 64, which is attached to the car 63 and stores the member insurance service information of the policyholder, when an accident or trouble of the car 63 has happened; a transmitting means 22 for transmitting its cell phone number and the policyholder's name read out from the insurance IC tag 64 to the server 3 at a URL read out from the insurance IC tag 64; and a receiving means 23 for receiving an authentication result from the server 3. Here, the IC tag reading means 21 is capable of re-reading out the policyholder's name and the insurance policy number from the insurance IC tag 8, when the authentication result indicates being authenticated.

The cell phone 2 further comprises: a displaying means 24 for displaying the information re-read out; a selection means 25 for prompting the policyholder on the display to select whether to notify regarding the occurrence of an accident or not; and a location measuring means 26 for measuring the present location of the cell phone 2 based on the GPS. Here, the transmitting means 22 is capable of transmitting the policyholder's name, the insurance policy number, and the present location to the server 3.

The server 3 comprises: a member database 41 for storing the information on insurance polices of indemnification insurance services, for respective policyholders; a receiving means 42 for receiving a cell phone number and a policyholder's name from a cell phone 2; an authenticating means 43 for authenticating the received information by matching them with the data in the member database 41; and a transmitting means 44 for transmitting the authentication result to the cell phone 2. Here, the receiving means 42 is capable of receiving the policyholder's name, the insurance policy number, and the present location from the cell phone 2.

The server 3 further comprises: a storing means 45 for storing the received information to the member database 41; and a searching means 46 for searching the content of the insurance policy from the member database 41. Here, the transmitting means 44 is capable of transmitting the content of the insurance policy and the present location to the management terminal 5.

The management terminal 5 comprises: a receiving means 51 for receiving the content of the insurance policy and the present location from the server 3; a displaying means 52 for displaying the content of the insurance policy, and also displaying the present location on a map; and a transmitting means 65 for transmitting the present location and the content of the insurance policy to the car repair shop terminal 62, when these data have received from the server 3.

The car repair shop terminal 62 comprises: a receiving means 66 for receiving the content of the insurance policy and the present location from the management terminal 5; and a displaying means 67 for displaying them.

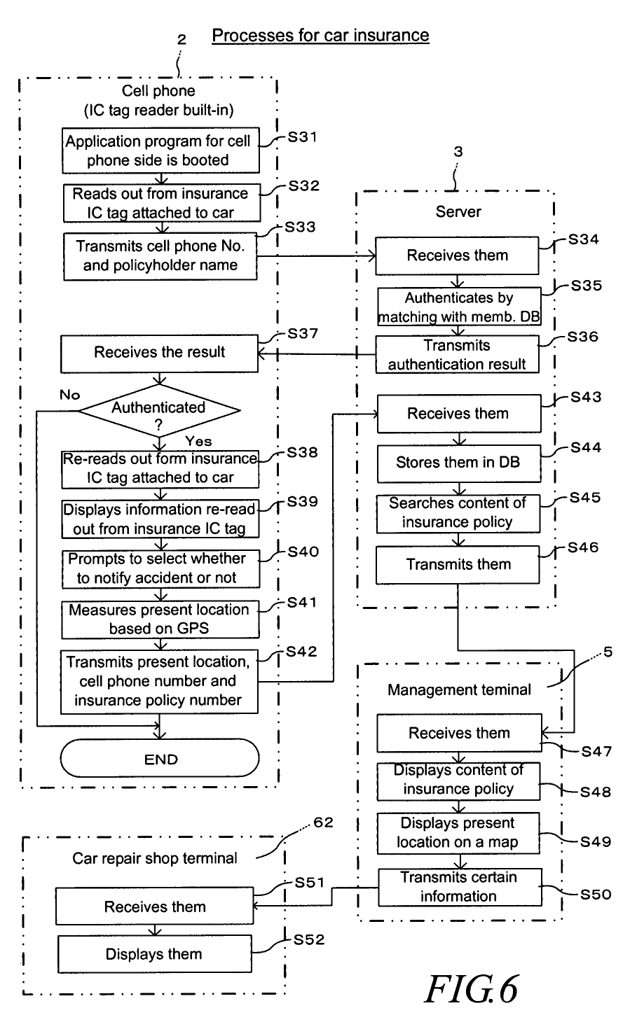

FIG. 6 is a diagram illustrating a flowchart for explaining the processes performed in a communication system for indemnification insurance service according to the second embodiment of the present invention.

When an accident or trouble of a car has happened, an application realizing the function on the cell phone 2 side is booted by the policyholder of the indemnification insurance (step S31); the member insurance service information is read out by the cell phone 2 from the insurance IC tag 64, which is attached to the car 63 and stores the member insurance service information of the policyholder (step S32), the cell phone 2 transmits the cell phone number and the policyholder's name read out from the insurance IC tag 8, to the server 3 at a URL read out from the insurance IC tag 8 (step S33).

The server 3, when having received the cell phone number and the policyholder's name from the cell phone 2 (step S34), authenticates the received data by matching them with the data in the member database 41 (step S35), and transmits the authentication result to the cell phone 2 (step S36).

The cell phone 2 receives the authentication result from the server 3 (step S37); when the authentication result indicates being authenticated, the cell phone 2 is allowed to re-read out the policyholder's name and the insurance policy number from the insurance IC tag 64 (step S38), displays the information re-read out (step S39); when the notification of the accident is selected by the policyholder on the display (step S40), the cell phone 2 measures the present position of the cell phone 2 based on the GPS (step S41), and transmits the policyholder's name, the insurance policy number, and present location (step S42). Here, when the authentication result doesn't indicate being authenticated, process is terminated.

The server 3, when having received the policyholder's name, the insurance number, and the present invention from the cell phone 2 (step S43), stores the received data in the member database 41 (step S44), then searches the contents of the insurance policy from the member database 41 (step S45), and transmits them to the management terminal 5 (step S46).

The management terminal 5, when having received the contents of the insurance policy and the present invention (step S47), displays the contents of the insurance policy (step S48), and also displays the present location on a map (step S49), and further transmits a certain portion of the content of the insurance policy and the present location to the car repair shop terminal 62 (step S50).

The car repair shop terminal 62, when having received the information from the management terminal 5 (step S51), displays the received information (step S52), and thereby making it possible to start a provision of the repair.

Hitherto, explanations are performed by exemplifying car insurance and an insurance IC tag attached to the car, regarding the communication system for indemnification insurance service according to the second embodiment of the present invention. Here, it is also possible to apply the communication system for indemnification insurance service according to the second embodiment of the present invention to the another kind of indemnification insurance services, by attaching the insurance IC tag to another objective materials, for example such as a bicycle, motorcycle, house, instead of a car.

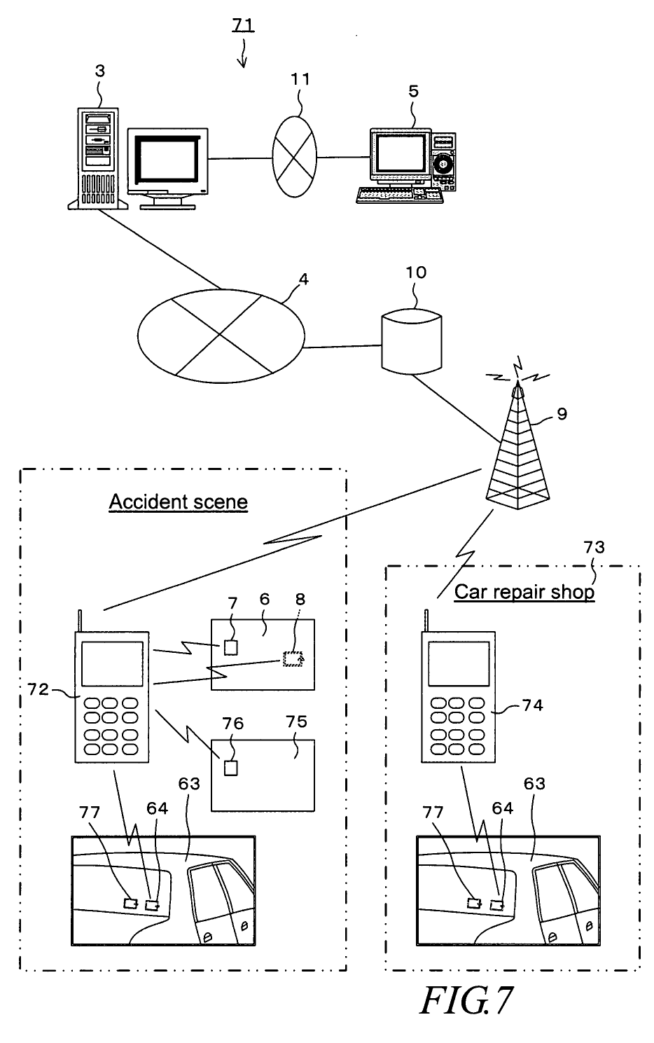

In FIG. 7, reference numeral 71 denotes a communication system for indemnification insurance service according to the third embodiment of the present invention; the system is available to the staff of an indemnification insurance company at a car accident scene.

The communication system for indemnification insurance service 71 comprises: a staff dedicated cell phone 72, which is to be carried by a staff of the indemnification company and has a built-in IC chip reader and a built-in IC tag reader; and a server 3 communicably connected with the terminal 72 over the internet 4. Moreover, a shop dedicated terminal 74 with a built-in IC tag reader and writer is installed in the car repair shop 73. Here, in FIG. 7, reference numeral 75 denotes a company staff card carried by a staff of the indemnification insurance company, reference numeral 76 denotes an IC chip provided with the company staff card 75, and reference numeral 77 denotes a car examination IC tag, which is attached to the car and stores examination information on the car.

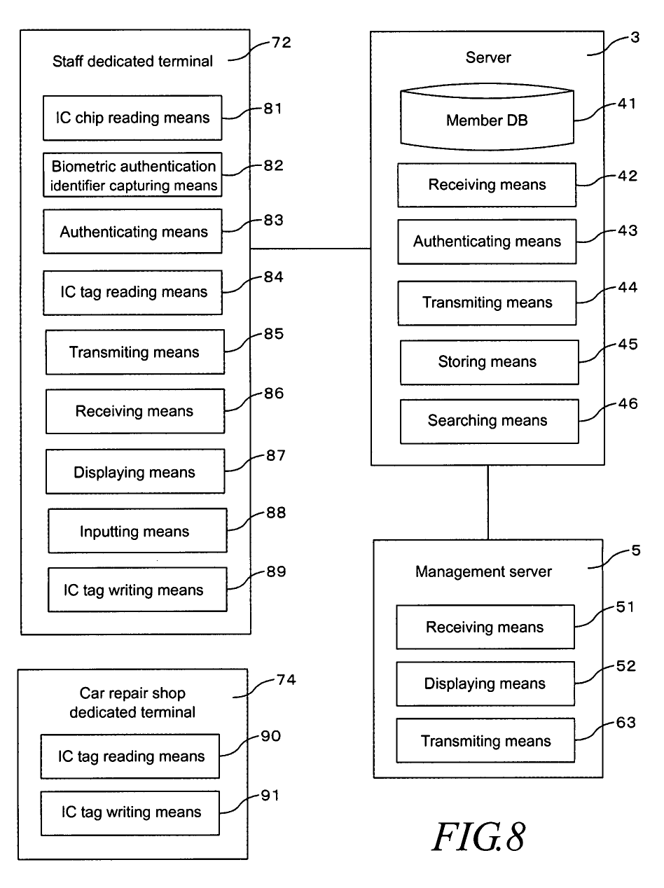

As shown in FIG. 8, the staff dedicated terminal 72 comprises: an IC chip reading means 81 operable to read out the biometric authentication identifier stored in the IC chip 76 provided in the company staff card 75 of a staff of the indemnification insurance company; a biometric authentication identifier capturing means 82 for capturing a biometric authentication identifier from the stuff of the indemnification insurance company; and an authenticating means 83 for authenticating the staff of the indemnification insurance company. Here, the IC chip reading means 81 is also operable to read out the biometric authentication identifier stored in the IC chip 7 of the insurance card 6 possessed by the policyholder. Moreover, the biometric authentication capturing means 82 is also capable of capturing the biometric authentication identifier, and the authenticating means 83 is also operable to authenticate the policyholder.

The staff dedicated terminal 72, further, comprises: an IC tag reading means 84 operable to read out indemnification insurance service information of the policyholder stored in the insurance IC tag 8 of the insurance card 6, when the staff of the indemnification insurance company and the policyholder are authenticated, wherein the indemnification insurance service information includes such as the policyholder's name, URL of the server, insurance policy number, input data to be described below and so on; a transmitting means 85 for transmitting the policyholder's name of the insurance service read out from the insurance IC tag 8 to the server 3 at a URL read out from the insurance IC tag 8; a receiving means 86 for receiving an authentication result from the server 3; and a displaying means 87 for displaying insurance IC tag information read out from the insurance IC tag 8, when the authentication result indicates being authenticated. Here, the IC tag reading means 84 is also operable to read out information from the car examination IC tag 77, which is attached to the car and stores the examination information on the car, and the displaying means 87 is capable of displaying the information read from car examination IC tag.

The staff dedicated terminal 72, yet further comprises an inputting means 88 allowing the staff to input the data regarding, such as the insurance procedure, the accident management, and the like at the accident scene. Here, the transmitting means 85 is also capable of transmitting information read out from the car examination IC tag and the input data, to the server 3.

The staff dedicated terminal 72 still further comprises an IC tag writing means 89 operable to write the historical data of an accident(s) to the insurance IC tag 64 attached to the car and the insurance IC tag 8 of the insurance card 6.

The shop dedicated terminal 74 installed in the car repair shop 73 comprises: an IC tag reading means 90 operable to read out data from the car examination IC tag 77 attached to the car 63; and an IC tag writing means 91 operable to update data of car repair saved in the car examination IC tag 77.

The server 3 comprises: a member database 41 for storing the information on insurance polices of indemnification insurance services, for respective policyholders; a receiving means 42 for receiving the IC tag information read out from the insurance IC tag 8 of the insurance card 6 from the staff dedicated terminal 72; an authenticating means 43 for authenticating the received information by matching them with the data in the member database 41; a transmitting means 44 for transmitting the authentication result to the staff dedicated terminal 72; and a storing means 45 for storing the information read from the car examination IC tag and the input data to the member database 41, when these data have received.

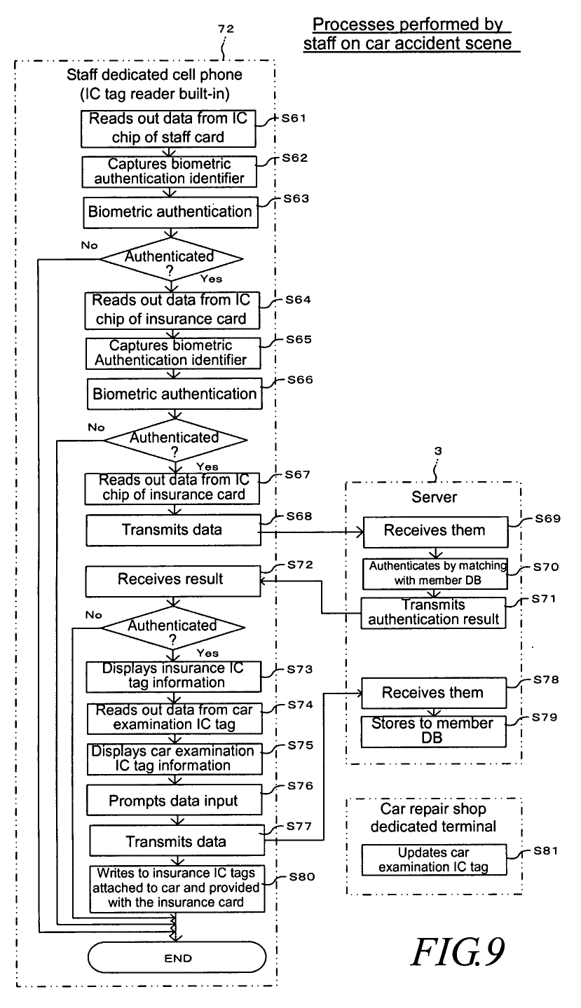

FIG. 9 is a diagram illustrating a flowchart for explaining the processes performed in a communication system for indemnification insurance service according to the third embodiment of the present invention.

When an accident or trouble of a car has happened, the biometric authentication identifier is read out by the staff dedicated terminal 72, wherein the identifier is/are stored in the IC chip 76 provided in the staff card 75 of the staff of the indemnification insurance company (step S61); the staff dedicated terminal 72 captures a biometric authentication identifier from the staff of the indemnification insurance company (step S62); and authenticates the staff of the indemnification insurance company (step S63).

Then the biometric authentication identifier stored in the IC chip 7 of the insurance card 6 possessed by the policyholder is/are read by the staff dedicated terminal 72 (step S64); the staff dedicated terminal 72 captures the biometric authentication identifier policyholder (step S65); and authenticates the policyholder (step S66). Next, when the staff of the indemnification insurance company and the policyholder are authenticated, the indemnification insurance service information of the policyholder is read out by the staff dedicated terminal 72 (step S67); and the staff dedicated terminal 72 transmits the information read out from the insurance IC tag 8, to the server 3 at a URL also read out from the insurance IC tag 8 (step S68).

The server 3, when having received from the staff dedicated terminal 72, the information read out from the insurance policy IC tag 8 provided with the insurance card 6 (step S69), authenticates the received data by matching them with the data in the member database 41 (step S70); and transmits the authentication result to the staff dedicated terminal 72 (step S71).

The staff dedicated terminal 72 receives the authentication result from the server 3 (step S72); when the authentication result indicates being authenticated, the terminal 72 displays the insurance IC tag information read out from the insurance IC tag 8 (step S73), reads out the data from the car examination IC tag 77, which is attached to the car and stores the examination information on the car (step S74); displays the information read out from the car examination IC tag 77 (step S75); allows the staff to input data regarding, such as insurance procedure, accident management, and the like at the accident scene (step S76); and transmits the information on the car examination IC tag 77 and the input data to the server 3 (step S77). Here, when authentication is not obtained at the step S 63 or S66, or when the authentication result received at the step S72 doesn't indicate being authenticated, the process terminates.

The server 3, when having received the data read out from the car examination IC tag 77 and the input data from the staff dedicated terminal 72 (step S78), stores the received data to the member database 41 (step S79).

Further, the historical data of the accident are written by the staff dedicated terminal 72 to the insurance IC tag 64 attached to the car and to the insurance IC tag 8 of the insurance card 6 (step S80).

When the repair of the car 63 has finished in the car repair shop 73, the shop dedicated terminal 74 installed in the car repair shop 73 updates the historical data of repair stored in the car examination IC tag 77 attached to the car 63 (step S81).

What is claimed is:

1. A communication system for indemnification insurance service, the system comprising: a cell phone with a built-in IC tag reader; a server communicably connected with said cell phone over the internet; and a management terminal communicably connected with said management server;
wherein said cell phone includes:
a reading means operable to read, after such as an occurrence of an accident, insurance service information stored in an insurance IC tag provided with an insurance card possessed by a policyholder of the indemnification insurance service;
a transmitting means for transmitting its cell phone number and a policyholder's name read from said insurance IC tag to said server at a URL read from said insurance IC tag;
a receiving means for receiving an authentication result from said server, wherein when the authentication result indicates being authenticated, said reading means is operable to re-read the policyholder's name and the insurance policy number from said insurance IC tag;
a displaying means for displaying the re-read information;
a means for prompting, on a display, the policyholder to select whether to notify regarding an occurrence of an accident or not; and
a measuring means for measuring the present location of the cell phone based on the GPS, wherein said transmitting means transmits the policyholder's name, the insurance policy number, and the present location to the server;
and wherein said server includes:
a member database for storing the information on the policyholder of the indemnification insurance service;
an authentication means for authenticating, when the cell phone number and the policyholder' name have received from the cell phone, by matching them with data in said member database;
a transmitting means for transmitting the authentication result to the cell phone;
a means for storing the policyholder' name, the insurance policy number, and the present location to said member database, when these data have received; and
a searching means for searching the content of the insurance policy from said member database, wherein, said transmitting means transmits the content of the insurance policy and the present location to said management terminal;
and wherein said management terminal includes:
a means for displaying the content of the insurance policy and also displaying the present location on a map, on receiving these data.

2. A communication system for indemnification insurance service, the system comprising: a cell phone with a built-in IC tag reader; a server communicably connected with said cell phone over the internet; and a management terminal communicably connected with said management server;
wherein said cell phone includes:
a reading means operable to read, after such as an occurrence of an accident and/or trouble of a car, member insurance service information stored in an insurance IC tag attached to the car;
a transmitting means for transmitting its cell phone number and a policyholder's name read from said insurance IC tag to said server at a URL read from said insurance IC tag;
a receiving means for receiving an authentication result from said server, wherein when the authentication result indicates being authenticated, said reading means is operable to re-read the policyholder's name and the insurance policy number from said insurance IC tag;
a displaying means for displaying the re-read information;
a means for prompting, on a display, the policyholder to select whether to notify regarding an occurrence of an accident or not; and
a measuring means for measuring the present location of the cell phone based on the GPS, wherein said transmitting means transmits the policyholder's name, the insurance policy number, and the present location to the server;
and wherein said server includes:
a member database for storing the information on the policyholder of the indemnification insurance service;
an authentication means for authenticating, when the cell phone number and the policyholder' name have received from the cell phone, by matching them with data in said member database;
a transmitting means for transmitting the authentication result to the cell phone;
a means for storing the policyholder' name, the insurance policy number, and the present location to said member database, when these data have received; and
a searching means for searching the content of the insurance policy from said member database, wherein, said transmitting means transmits the content of the insurance policy and the present location to said management terminal;
and wherein said management terminal includes:
a means for displaying the content of the insurance policy and also displaying the present location on a map, on receiving these data.

3. A communication system for indemnification insurance service according to claim 2, wherein
said management terminal is communicably connected with a car repair shop terminal installed in a car repair shop;
said transmitting means of said management terminal transmits the content of the insurance policy and the present location to the car repair shop terminal, on receiving these data from said server; and
said car repair shop terminal includes a means for displaying the content of the insurance policy and the present location, on receiving these data from said management terminal.

4. A communication system for indemnification insurance service, the system comprising: a staff dedicated terminal with a built-in IC chip reader and a built-in IC tag reader, carried by a staff of a company of an indemnification insurance service; and a server communicably connected with said staff dedicated terminal over the internet;
wherein said staff dedicated terminal includes:
a reading means operable to read a biometric authentication identifier stored in an IC chip provided with a company staff card of the staff of the indemnification insurance company;
an authentication identifier capturing means for capturing a biometric authentication identifier from the staff of the indemnification insurance company; and
an authenticating means for authenticating the staff of an indemnification insurance company, wherein said reading means is operable to read biometric authentication identifier stored in the IC chip of an insurance card possessed by a policyholder of the indemnification insurance service, said authentication identifier capturing means is operable to capture biometric authentication identifier of the policy holder, said authenticating means authenticates the policyholder, and said reading means, when said staff of the company of the indemnification insurance service and said policyholder are authenticated, is operable to read indemnification insurance service information of said policyholder from the insurance IC tag of the insurance card;
and wherein said staff dedicated terminal further includes:
a transmitting means for transmitting the policyholder's name read from the insurance IC tag to the server at a URL read from the insurance IC tag;
a receiving means for receiving an authentication result from said server;
a displaying means for displaying the insurance IC tag information read from said insurance IC tag, when the authentication result indicates being authenticated, wherein after being authenticated, the reading means is operable to read examination information of a car from a car examination IC tag attached to the car, and the displaying means displays examination information of the car;
and wherein said staff dedicated terminal further includes:
an inputting means for allowing the staff to input data on procedures and/or managements regarding the accident at the accident scene, wherein after the data input, the transmitting means transmits the car examination IC tag information and the input data to the server;
and wherein said staff dedicated terminal further includes:
a writing means operable to write the input data to the insurance IC tag of the insurance card and the insurance IC tag attached to the car;
and wherein said server includes:
a member database for storing the information on the policyholder of the indemnification insurance service;
an authentication means for authenticating, when the insurance IC tag information of the insurance card has been received from the staff dedicated terminal, by matching them with data in said member database;
a transmitting means for transmitting the authentication result to the staff dedicated terminal; and
a means for storing the car examination IC tag information and the input data to the member database, when these data have received.

5. A communication system for indemnification insurance service according to claim 4, wherein said staff dedicated terminal includes a writing means operable to write historical data of a happened accident(s) and/or trouble(s) to the insurance IC tag attached to the car and the insurance IC tag of the insurance card.

6. A communication system for indemnification insurance service according to claim 4, wherein said car examination IC tag is capable to be updated regarding the historical data of repair therein, by a shop dedicated terminal installed in a car repair shop.
